(19) United States
(12) Patent Application Publication
(10) Pub. No.: US 2016/0112939 A1
(43) Pub. Date: Apr. 21, 2016

(54) METHOD AND APPARATUS FOR TETHERED DEVICE TO SELECT EXTERNAL DATA NETWORK

(71) Applicant: MOTOROLA SOLUTIONS, INC, SCHAUMBURG, IL (US)

(72) Inventors: THOMAS J. SENESE, SCHAUMBURG, IL (US); RALPH K. BARRETT, CORAL SPRINGS, FL (US); HOPE E. BRAUN, CHICAGO, IL (US)

(21) Appl. No.: 14/515,691

(22) Filed: Oct. 16, 2014

(51) Int. Cl. H04W 48/18; H04W 4/00; H04B 7/26; H04W 16/14

(52) U.S. Cl. CPC H04W 48/18; H04W 16/14; H04W 4/008; H04B 7/26; H04W 84/12

(57) ABSTRACT

A method for a tethered device to select an external data network includes selecting a desired data network at the tethered device through an associated Access Point Name; sending the associated Access Point Name to a broadband device via a control message over a collaboration interface with the broadband device; and sending data to the broadband device destined for the desired data network over the collaboration interface, wherein the broadband device is configured to send the data to the desired data network based on the associated Access Point Name.

### BACKGROUND OF THE INVENTION

In wireless networking systems, in order to provide device collaboration between a narrowband device, such as a Land Mobile Radio (LMR) device, and a broadband device, such as a Long Term Evolution (LTE) device, a local wireless link is established between the narrowband device and the broadband device, i.e. the broadband device tethers the narrowband device to its wireless broadband backhaul. The narrowband device can access broadband services, over the established local wireless link, through the broadband device, which connects to a broadband network (e.g., LTE network). After the broadband device registers with the broadband network, an air interface bearer of the broadband device is attached to a desired external data network. The desired data network is distinguished using an Access Point Name (APN) which is specified by the broadband device during registration. A General packet radio service (GPRS) connection is established by reference to its access point name (APN). The APN defines the services such as wireless application protocol (WAP) access, short message service (SMS), multimedia messaging service (MMS), and for Internet communication services such as email and World Wide Web access. Conventionally, the narrowband device cannot select a desired data network by specifying the APN where the broadband data of the broadband device is sent. Specifically, GPRS from the 3rd Generation Partnership Project (3GPP) defines the concept of APNs and how APNs are selectable, by the broadband device. However, it is not disclosed how a tethered (or collaborating) device commands the broadband device to select a desired APN.

Accordingly, there is a need for a method and apparatus for a tethered device to select an external data network.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a network diagram of a tethered configuration in accordance with some embodiments.

FIG. 2 is a flow chart of a method for a tethered device to select an external data network in accordance with some embodiments.

FIG. 3 is a network diagram of an exemplary application of the method of FIG. 2 in accordance with some embodiments.

FIG. 4 is a network diagram of another exemplary application of the method of FIG. 2 in accordance with some embodiments.

FIG. 5 is a network diagram of a further exemplary application of the method of FIG. 2 in accordance with some embodiments.

FIG. 6 is a block diagram of a mobile device, which may be used for the broadband device or the narrowband device in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In an exemplary embodiment, a method for a tethered device to select an external data network includes selecting a desired data network at the tethered device through an associated Access Point Name; sending the associated Access Point Name to a broadband device via a control message over a collaboration interface with the broadband device; and sending data to the broadband device destined for the desired data network over the collaboration interface, wherein the broadband device is configured to send the data to the desired data network based on the associated Access Point Name.

In another exemplary embodiment, a method for a broadband device to select an external data network based on selection from a tethered device includes establishing a collaboration interface with the tethered device; receiving an associated Access Point Name for a desired data network selected by the tethered device, via the collaboration interface; performing bearer attachment to the desired data network based on the associated Access Point Name; and sending data, from the tethered device over the collaboration interface, to the desired data network.

In a further exemplary embodiment, a mobile device includes a Wireless Local Area Network interface configured to form a collaboration interface with a broadband device; a narrowband network interface to a narrowband network; a processor communicatively coupled to the Wireless Local Area Network interface and the narrowband network interface; and memory storing instructions that, when executed, cause the processor to select a desired data network at the mobile device through an associated Access Point Name; send the associated Access Point Name to a broadband device via a control message over the collaboration interface; and send data to the broadband device destined for the desired data network over the collaboration interface, wherein the broadband device is configured to send the data to the desired data network based on the associated Access Point Name.

In various exemplary embodiments, a method and apparatus are described for a tethered device to select an external data network. The method and apparatus allows a collaborating device, without a broadband interface, to select a specific APN that a broadband device will attach its bearer to, and the APN selection does not require operator intervention on the broadband device. For example, an LMR device provides an APN parameter to a broadband device, such as User Equipment (UE) using LTE, on a wireless collaboration interface, such as Bluetooth, Wi-Fi (IEEE 802.11 and variants thereof), and the broadband device (UE) uses the APN parameter “as is” to establish the connection identified by the APN (and the associated LTE bearer), according to the LTE standard procedures.

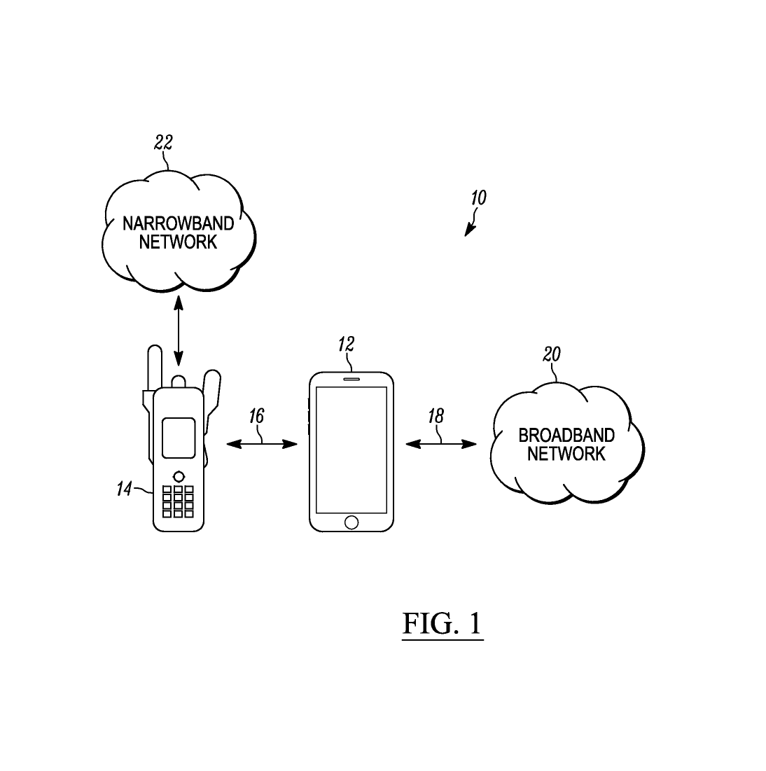

FIG. 1 is a network diagram of a tethered configuration 10 in accordance with some embodiments. Specifically, the tethered configuration 10 includes a broadband device 12 and a narrowband device 14. With the method and apparatus and the tethered configuration 10, the narrowband device 14 can include a communication link 16 which tethers the narrowband device 14 to the broadband device 12. That is, the communication link 16 is configured to provide tethering between the narrowband device 14 and the broadband device 12.

The broadband device 12 includes a communication link 18 with a broadband network 20. The narrowband device 14 is configured to communicate on a narrowband network 22, and does not have a broadband network interface, for communicating on the broadband network 20. The broadband network interface is a Wireless Wide Area Network (WWAN) network interface for the communication link 18. In an exemplary embodiment, the broadband network 20 can be an LTE network, and the WWAN network interface can be an LTE interface; other embodiments are also contemplated. Also, in an exemplary embodiment, the narrowband device 14 can include a Land Mobile Radio (LMR) device; other embodiments are also contemplated.

The broadband device 12 and the narrowband device 14 each includes a Wireless Local Area Network (WLAN) network interface for the communication link 16. The tethering is through the communication link 16. Tethering refers to connecting one device to another, i.e. the narrowband device 14 with the broadband device 12. This allows the narrowband device 14 to share the communication link 18 to the broadband network 20. The communication link 16, through the associated WLAN network interfaces, can be Wi-Fi (IEEE 802.11 and variants thereof), Bluetooth, Bluetooth Low Energy, Wireless Universal Serial Bus (WUSB), ZigBee (IEEE 802.15 and variants thereof), or the like. Also, the communication link 16 can also be a wired connection between the broadband device 12 and the narrowband device 14.

If the tethered configuration 10 is done over Wi-Fi, the broadband device 12 can be referred to as a Mobile Hotspot with the broadband device 12 acting as a portable wireless access point and router the narrowband device 14. At the Internet Protocol (IP) layer, the tethering normally works via Network Address Translation (NAT) on the communication link 18, so from the broadband network 20's point of view, there is just one device with a single IP network address.

For the communication link 18 and the broadband network 20, an Access Point Name (APN) is the name of a gateway between the broadband network 20 and another network, such as the Internet, Wide Area Network (WAN), Virtual Private Network (VPN), enterprise network, public safety network, and the like. For data connections through the communication link 18, an APN must be configured for the broadband network 20. The broadband network 20 examines this APN identifier to determine what type of network connection should be created, for example: what IP addresses should be assigned to the broadband device 12, what security methods should be used, and how or if, it should be connected to some private network.

More specifically, the APN identifies the packet data network (PDN) for communication through the broadband network 20. In addition to identifying a PDN, the APN may also be used to define the type of service, (e.g. connection to wireless application protocol (WAP) server, multimedia messaging service (MMS)) that is provided by the PDN. APN is used in 3GPP data access networks, e.g. general packet radio service (GPRS), evolved packet core (EPC), etc.

The APN structure includes a network identifier and an operator identifier such as: network_id.mnc<MNC>.mcc<MCC>.gprs where network_id is the network identifier and mnc<MNC>.mcc<MCC>.gprs is the operator identifier. The network identifier can define the external network to which the broadband network 20 is connected. Optionally, the network identifier may also include the service requested by the user. This network identifier of the APN is mandatory. The operator identifier can define the specific operator's packet domain network in which a Gateway GPRS Support Node (GGSN) is located. The operator identifier of the APN is optional. The MCC is the Mobile Country Code and the MNC is the Mobile Network Code which together uniquely identify a mobile network operator. In an exemplary embodiment, the APN is an APN such as defined in Section 9, Definition of Access Point Name, of the 3rd Generation Partnership Project (3GPP) Technical Specification (TS) 22.003 standard for Numbering, addressing, and identification (3GPP TS 23.003).

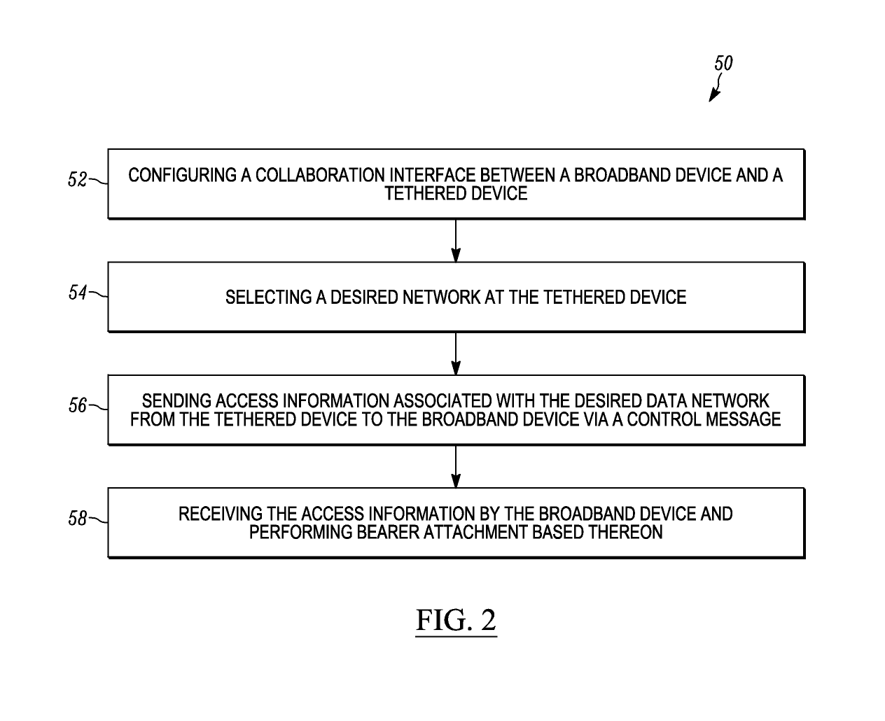

FIG. 2 is a flow chart of a method 50 for a tethered device to select an external data network in accordance with some embodiments. In some embodiments, the method 50 may include more or less steps and/or different ordering of the steps. The method 50 contemplates operation on and between the broadband device 12 and the narrowband device 14. For example, the narrowband device 14 can be referred to as a tethered device. The method 50 includes configuring a collaboration interface between a broadband device and a tethered device (step 52). The broadband device can be the broadband device 12, the tethered device can be the narrowband device 14, and the collaboration interface can be the communication link 16. The collaboration interface can be Wi-Fi (IEEE 802.11 and variants thereof), Bluetooth, Bluetooth Low Energy, WUSB, ZigBee (IEEE 802.15 and variants thereof), or the like.

The method 50 includes selecting a desired data network at the tethered device (step 54). This can include selecting a desired data network at the tethered device through an associated Access Point Name. Here, the desired data network, for the tethered device, is determined through selecting an APN. There are a variety of ways that the APN is selected at the tethered device. For example, a user can input the APN name at the tethered device, the user can select an APN through a menu or the like with pre-programmed APN values at the tethered device, the APN could be programmed automatically into a mode on the tethered device, etc. For example, a mode can be selected at the tethered device, such as through a Channel Selector Switch, and the APN is indirectly selected when the mode is directly selected. The APN is selected, at the tethered device, based on the services being performed by the tethered device.

The method 50 includes sending access information associated with the desired data network from the tethered device to the broadband device via a control message (step 56). This can include sending the associated Access Point Name to a broadband device via a control message over a collaboration interface with the broadband device. Note, the protocol used for the collaboration interface, i.e. the communication link 16, has associated control messages, such as through Wi-Fi, Bluetooth, WUSB, ZigBee, etc. The control message includes the APN of the desired network to which the broadband device is to be attached, for the tethered device.

The method 50 includes receiving the access information by the broadband device and performing bearer attachment based thereon (step 58). On receiving the control message, the broadband device performs Bearer Attachment with a data network using the APN specified in the control message by the tethered device. That is, the broadband device can perform a new Bearer Attachment transaction with the network using the APN specified by the tethered device. For example, the broadband device can be an LTE UE, and the Bearer Attachment can utilize procedures outlined in the LTE specifications.

After the broadband device registers on a wireless network, such as the broadband network 20, it establishes an attachment between its air interface bearer with a virtual tunnel to an external data network. In LTE, this step is called Bearer Attachment. The distinguished name of the external data network is referenced by the Access Point Name (APN). The broadband device specifies the APN for the desired data network during the Bearer Attachment transaction. With the method 50, the broadband device can have two or more Bearer Attachments, selectable by the narrowband device.

The method 50 allows the tethered device, such as an LMR device, to specify the APN where its broadband data will be sent. That is, sending data to the broadband device destined for the desired data network over the collaboration interface, wherein the broadband device is configured to send the data to the desired data network based on the associated Access Point Name. The following are some example use cases where the LMR device needs to specify the APN for a particular external data network. In an exemplary embodiment, the broadband device, in stand-alone mode, is used for commercial applications, and always attaches to the APN associated with the IP Multimedia Subsystem (IMS) for the public carrier. When a collaborative link is established with the LMR device, the LMR device needs a means to establish an attachment to the APN for an agency data network, for a public safety agency.

In another exemplary embodiment, the LMR device needs to attach to a different APN upon moving into a new jurisdictional area. In a further exemplary embodiment, the LMR device needs to attach to a different APN in order to access a specific application that is only available in the external data network referenced by the APN. Thus, the method 50 allows an LMR device or any other tethered device to access broadband data services through the collaborative interface of the broadband device. The broadband device tethers the LMR device to its wireless broadband backhaul. The collaborative interface between the LMR device and broadband device can be Bluetooth, Wi-Fi, or another appropriate interface. The broadband backhaul interface can be 4G LTE, 3G, or another appropriate interface.

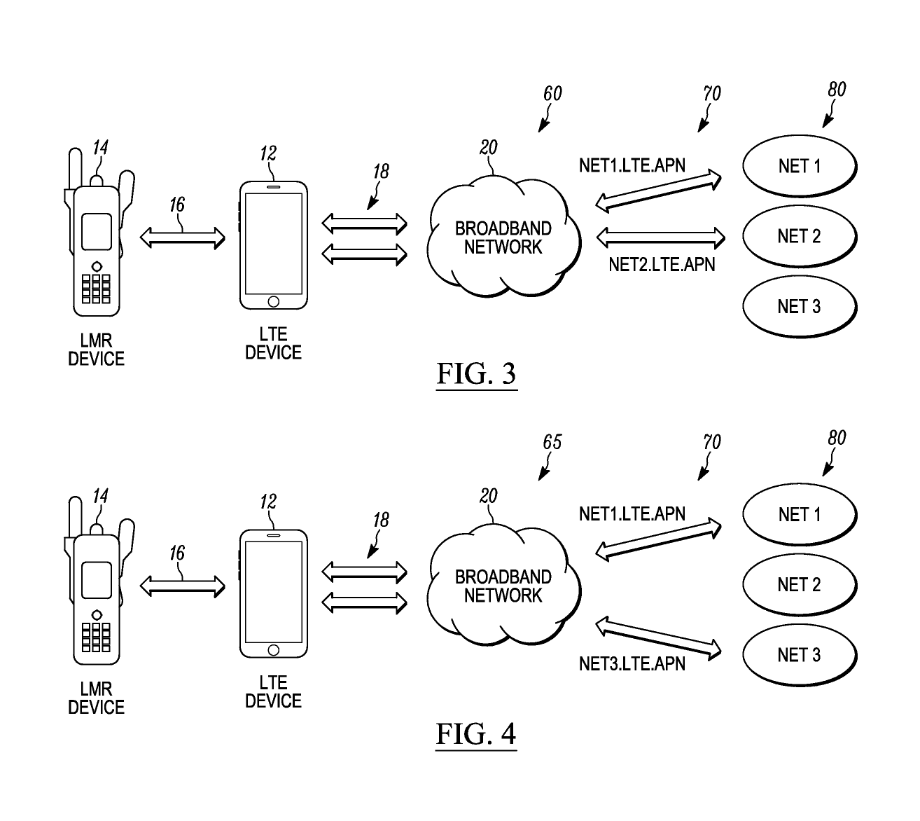

FIG. 3 is a network diagram of an exemplary application 60 of the method 50 in accordance with some embodiments. Here, the narrowband device 14 is an LMR device, the broadband device 12 is an LTE device, and the communication link 16 is a Bluetooth link. The LMR device connects to an LTE device for broadband collaboration over the Bluetooth link. The LMR device specifies that the LTE Device should request a bearer that attaches to APN 2 (NET2.LTE.APN) 70. The LMR device's data traverses the bearer for APN 2 60. The LTE device's data traverses the bearer for APN 1 (NET1.LTE.APN) 70. Thus, the LTE device can have two or more APNs.

FIG. 4 is a network diagram of another exemplary application 65 of the method 50 in accordance with some embodiments. Similar to the exemplary application 60, in the exemplary application 65, the LMR Device switches to a different mode (e.g., via channel selector switch). The parameters for this mode specify that APN 3 70 must be used for the data pipe. The LMR Device notifies the LTE Device to set up a new bearer. The new bearer requires attachment to APN 3 70, and also results in the tear-down of the previous bearer for APN 2 70.

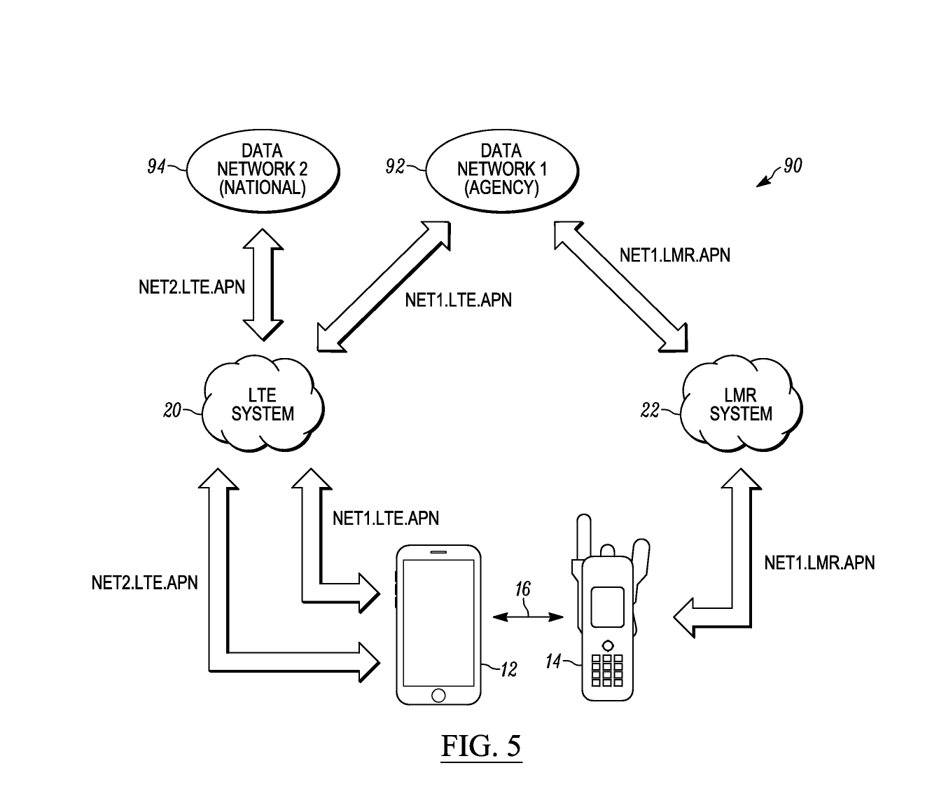

FIG. 5 is a network diagram of a further exemplary application 90 of the method 50 in accordance with some embodiments. Again, the broadband device 12 can be an LTE device with the broadband network 20 as an LTE network, and the narrowband device 14 can be an LMR device with the narrowband network as an LMR network. The LMR device is tethered to the LTE device via the communication link 16. The LTE device is configured with two or more APNs 70, NET1.LTE.APN for access to a data network 1 92, such as a public safety agency network, and NET2.LTE.APN for access to a data network 2 94, such as a national network.

The method 50 enables APN selection at the LMR device rather than on the LTE device. The transmission of the APN parameter is over control signaling over the collaboration interface between the LMR Device and the LTE Device. This enables the LMR Device to specify which APN the LTE Device should attach to after setting up a bearer that is dedicated to the LMR Device's data traffic. This provides value to older LMR devices or the like that do not possess an internal broadband modem, and to Public Safety LTE devices that offer a feature that is not available in commercial smartphones or tablets.

### Mobile Device

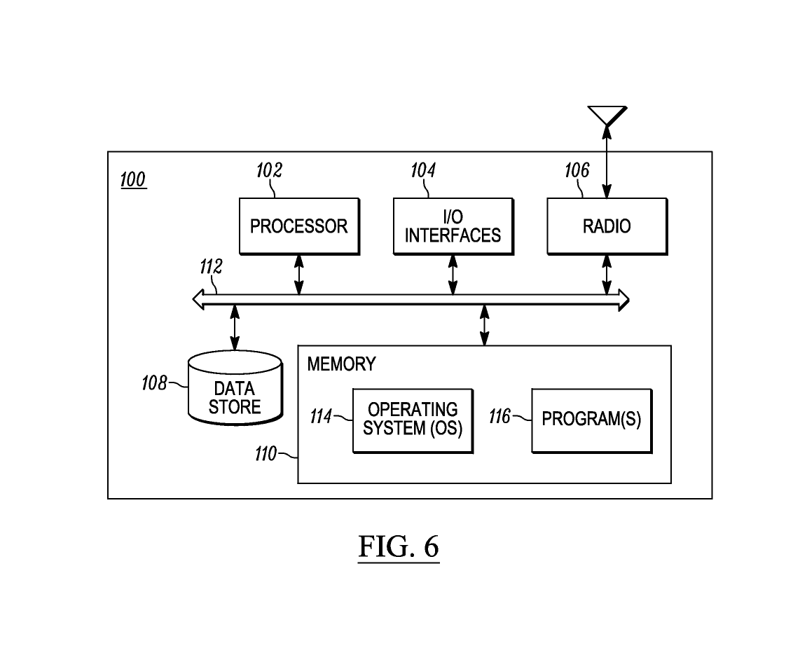

FIG. 6 is a block diagram of a mobile device 100, which may be used for the broadband device 12 or the narrowband device 14 in accordance with some embodiments. For example, the mobile device 100 can include, without limitation, a smart phone, a two-way radio, a tablet, a vehicle modem, a drone/robot, etc. The mobile device 100 can be a digital device that, in terms of hardware architecture, generally includes a processor 102, input/output (I/O) interfaces 104, radio(s) 106, a data store 108, and memory 110. It should be appreciated by those of ordinary skill in the art that FIG. 6 depicts the mobile device 100 in an oversimplified manner, and a practical embodiment may include additional components and suitably configured processing logic to support known or conventional operating features that are not described in detail herein. The components (102, 104, 106, 108, and 110) are communicatively coupled via a local interface 112. The local interface 112 can be, for example but not limited to, one or more buses or other wired or wireless connections, as is known in the art. The local interface 112 can have additional elements, which are omitted for simplicity, such as controllers, buffers (caches), drivers, repeaters, and receivers, among many others, to enable communications. Further, the local interface 112 may include address, control, and/or data connections to enable appropriate communications among the aforementioned components.

The processor 102 is a hardware device for executing software instructions. The processor 102 can be any custom made or commercially available processor, a central processing unit (CPU), an auxiliary processor among several processors associated with the mobile device 100, a semiconductor-based microprocessor (in the form of a microchip or chip set), or generally any device for executing software instructions. When the mobile device 100 is in operation, the processor 102 is configured to execute software stored within the memory 110, to communicate data to and from the memory 110, and to generally control operations of the mobile device 100 pursuant to the software instructions. In an exemplary embodiment, the processor 102 may include a mobile optimized processor such as optimized for power consumption and mobile applications. The I/O interfaces 104 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 104 can also include, for example, a serial port, a parallel port, a small computer system interface (SCSI), an infrared (IR) interface, a radio frequency (RF) interface, a universal serial bus (USB) interface, and the like. The I/O interfaces 104 can include a graphical user interface (GUI) that enables a user to interact with the mobile device 100.

The radio 106 enables wireless communication to an external access device or network. Note, the radio 106 can include multiple radios with any number of suitable wireless data communication protocols, techniques, or methodologies can be supported by the radio 106, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); Land Mobile Radio (LMR); Digital Mobile Radio (DMR); Terrestrial Trunked Radio (TETRA); Project 25 (P25); and any other protocols for wireless communication. In an exemplary embodiment, the radio 106 includes a WWAN interface and a WLAN interface. The data store 108 may be used to store data. The data store 108 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 108 may incorporate electronic, magnetic, optical, and/or other types of storage media.

The memory 110 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 110 may incorporate electronic, magnetic, optical, and/or other types of storage media. Note that the memory 110 may have a distributed architecture, where various components are situated remotely from one another, but can be accessed by the processor 102. The software in memory 110 can include one or more software programs, each of which includes an ordered listing of executable instructions for implementing logical functions. In the example of FIG. 6, the software in the memory 110 includes a suitable operating system (O/S) 114 and programs 116. The operating system 114 essentially controls the execution of other computer programs, and provides scheduling, input-output control, file and data management, memory management, and communication control and related services. The programs 116 may include various applications, add-ons, etc. configured to provide end user functionality with the mobile device 100.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for a tethered device to select an external data network, the method comprising:
selecting a desired data network at the tethered device through an associated Access Point Name;
sending the associated Access Point Name to a broadband device via a control message over a collaboration interface with the broadband device; and
sending data to the broadband device destined for the desired data network over the collaboration interface, wherein the broadband device is configured to send the data to the desired data network based on the associated Access Point Name.

2. The method of claim 1, further comprising:
configuring the collaboration interface between the broadband device and the tethered device, wherein the control message is based on the collaboration interface.

3. The method of claim 1, wherein the broadband device is configured to send the data to the desired data network based on a bearer attachment to the desired data network.

4. The method of claim 1, wherein the collaboration interface is one of Wi-Fi (IEEE 802.11 and variants thereof), Bluetooth, Bluetooth Low Energy, Wireless Universal Serial Bus (WUSB), and ZigBee (IEEE 802.15 and variants thereof).

5. The method of claim 1, wherein the broadband device is a Long Term Evolution (LTE) device.

6. The method of claim 1, wherein the tethered device is a Land Mobile Radio (LMR) device.

7. The method of claim 1, wherein the desired data network is selected, at the tethered device, via one of user input, user selection from one or more networks, and user selection of a mode with the desired data network automatically selected based on the mode.

8. A method for a broadband device to select an external data network based on selection from a tethered device, the method comprising:
establishing a collaboration interface with the tethered device;
receiving an associated Access Point Name for a desired data network selected by the tethered device, via the collaboration interface;
performing bearer attachment to the desired data network based on the associated Access Point Name; and
sending data, from the tethered device over the collaboration interface, to the desired data network.

9. The method of claim 8, wherein the associated Access Point Name is received via a control message over the collaboration interface, wherein the control message is based on the collaboration interface.

10. The method of claim 8, wherein the collaboration interface is one of Wi-Fi (IEEE 802.11 and variants thereof), Bluetooth, Bluetooth Low Energy, Wireless Universal Serial Bus (WUSB), and ZigBee (IEEE 802.15 and variants thereof).

11. The method of claim 8, wherein the broadband device is a Long Term Evolution (LTE) device.

12. The method of claim 8, wherein the tethered device is a Land Mobile Radio (LMR) device.

13. The method of claim 8, wherein the desired data network is selected, at the tethered device, via one of user input, user selection from one or more networks, and user selection of a mode with the desired data network automatically selected based on the mode.

14. The method of claim 8, wherein the broadband device has two or more bearer attachments.

15. A mobile device, comprising:
a Wireless Local Area Network interface configured to form a collaboration interface with a broadband device;
a narrowband network interface to a narrowband network;
a processor communicatively coupled to the Wireless Local Area Network interface and the narrowband network interface; and
memory storing instructions that, when executed, cause the processor to
select a desired data network at the mobile device through an associated Access Point Name;
send the associated Access Point Name to a broadband device via a control message over the collaboration interface; and
send data to the broadband device destined for the desired data network over the collaboration interface, wherein the broadband device is configured to send the data to the desired data network based on the associated Access Point Name.

16. The mobile device of claim 15, wherein the broadband device is configured to send the data to the desired data network based on a bearer attachment to the desired data network.

17. The mobile device of claim 15, wherein the collaboration interface is one of Wi-Fi (IEEE 802.11 and variants thereof), Bluetooth, Bluetooth Low Energy, Wireless Universal Serial Bus (WUSB), and ZigBee (IEEE 802.15 and variants thereof).

18. The mobile device of claim 15, wherein the broadband device is a Long Term Evolution (LTE) device.

19. The mobile device of claim 15, wherein the mobile device is a Land Mobile Radio (LMR) device.

20. The mobile device of claim 15, wherein the desired data network is selected, at the mobile device, via one of user input, user selection from one or more networks, or user selection of a mode with the desired data network automatically selected based on the mode.
